(19) United States
(12) Patent Application Publication
(10) Pub. No.: US 2011/0000739 A1
(43) Pub. Date: Jan. 6, 2011

(54) SHIPPABLE SPEAKER BOX

(76) Inventors: Keith Carter, Maricopa, AZ (US); William Basore, Fountain Hills, AZ (US)

Correspondence Address: KEITH L. JENKINS, Registered Patent Attorney, LLC, 44075 W. Neely Drive, Maricopa, AZ, 85138, US

(21) Appl. No.: 12/497,628

(22) Filed: Jul. 3, 2009

(51) Int. Cl. H04R 1/02; A47B 81/06

(52) U.S. Cl. 181/199

(57) ABSTRACT

A speaker box, or enclosure, and kit with five panels connected by flexible couplings is shipped in a stack of four of the five panels, plus two side panels. The flexible couplings may be provided by a single sheet of fabric coupled to the five panels. When the kit is assembled into a speaker box, the five coupled panels circumferentially engage the two side panels, which are shaped as isosceles trapezoids. One side of the assembled speaker box includes two coupled panels, of the five coupled panels, joined with a flat rabbet joint. The assembled speaker box is held together with bundle ties, adhesive, or preferably, both. Openings for a speaker and a connector cup are provided. The kit includes adhesive, instructions, bundle ties with bundle tie locks, a connector cup, and hardware.

### FIELD OF THE INVENTION

The present invention relates to a box, or cabinet, for a loudspeaker, wherein the box has improved form for folding for shipment. The field of invention also relates to kits including the improved form, providing means to construct the shipped kit into a loudspeaker box.

### BACKGROUND OF THE INVENTION

Speaker boxes have been known in art for many years, having a generally rectangular shape or having one sloped face. They are known to be covered in carpet or other fabric.

Continuing challenges in the art are to reduce the form factor for shipping and to increase the speed of assembly. Retail establishments that offer assembly services for their customers have very tight timelines for assemblies. For example, one major retailer allows only ten minutes to completely assemble a speaker box, using untrained personnel.

US Patent Publication 2006/0165248 A1 to Butcher, et al. published Jul. 27, 2007 is a useful example of the challenges. Butcher shows four aligned panels held together with living hinges which are intended to fold up into a stack for shipping. In fact the four panels, as taught by Butcher, cannot fold up for shipping because of the nature of the joints that Butcher uses. Products have been sold, allegedly patent pending under Butcher's application, that have two sets of two panels flexibly connected by living hinges. The four-panel stack of Butcher does not work.

Hence, there is a need for a speaker box that can fold more sections completely and which can be quickly assembled by relatively unskilled personnel. There is also a need for a kit, based on a rapidly erectable speaker box that contains all associated parts and hardware to allow construction of a speaker box that is ready to receive a speaker. The present invention addresses these needs.

### BRIEF SUMMARY OF THE INVENTION

An improved shippable speaker box, including: five panels flexibly coupled in a linearly aligned sequence with four flexible couplings, including: a middle panel including four sides; first and second intermediate panels, each flexibly coupled to the middle panel on one of two opposite sides of the four sides, in the linearly aligned sequence; first and second outermost panels, each flexibly coupled to one respective intermediate panel in the linearly aligned sequence; the five panels able to be folded together into a configuration where the first and second intermediate panels and the first and second outermost panels are stacked generally parallel to each other without uncoupling the four flexible couplings; a sixth panel, including a first side panel sized and shaped to be circumferentially engaged by the five panels; a seventh panel, including a second side panel sized and shaped to be circumferentially engaged by the five panels, where the five panels, the sixth panel, and the seventh panel comprise seven panels able to be assembled into the improved shippable speaker box. The improved shippable speaker box, further including a eighth panel able in assembly of the speaker box to partition space interior to the speaker box into at least two separate portions. The improved shippable speaker box, combined in a kit including: the five panels, folded into the configuration where four panels of the five panels are parallel and the four flexible couplings remain coupled; and the sixth and the seventh panels are stacked parallel to the four parallel panels to form a stack. The improved shippable speaker box, where the kit further includes: a securer and/or a construction element. The improved shippable speaker box, where the securer includes a bundle tie lock further including a reinforced shoulder, the shoulder able to be used as a fulcrum for an adjustable pliers to tighten the bundle tie circumferentially around the speaker box during assembly. The improved shippable speaker box, where the securer includes an alignment frame. The improved shippable speaker box, where each of the five panels have a thickness; where the middle panel includes: an external length at least equal to combined the thicknesses of the first and second outermost panels; and an external length less than external lengths of each of the first and second intermediate panels and each of the first and second outermost panels. The improved shippable speaker box, where the first and second outermost panels have smaller external lengths than respective the first and second intermediate panels to which the first and second outermost panels are respectively flexibly coupled. The improved shippable speaker box where: at least one of the sixth panel and the seventh panel includes a connector cup opening; the kit further includes the connector cup; and at least one panel of the four panels includes a speaker opening. The improved shippable speaker box, where the panel including the connector cup opening and the panel including the speaker opening are adjacent in the stack; the connector cup opening and the speaker opening at least partially align to form a stack void within the stack; and a construction element of the kit is packaged to be shipped within the stack void. The improved shippable speaker box, where the kit further includes a retail package able to contain: the stack; the construction element; the connector cup; and the securer; and bearing, on a surface of the retail package, text relating to the speaker box and/or graphics relating to the speaker box. The improved shippable speaker box, where the construction element of the kit includes one or more of: an adhesive, assembly hardware, and a set of instructions. The improved shippable speaker box, further including first and second aligned grooves in each panel of the five panels, where the first and second grooves are configured to receive at least a portion of the first and the second side panels, respectively. The improved shippable speaker box, further including a third groove across four panels of the seven panels, the third groove able to receive an eighth panel, where the eighth panel is able, when the speaker box is assembled, to act as a partition interior to the speaker box. The improved shippable speaker box, where the four flexible couplings comprise one piece of flexible fabric coupled to the five panels.

An improved shippable speaker box, including: five panels flexibly coupled in a linearly aligned sequence with four flexible couplings; where the five panels are able to be folded together into a stacked configuration where four panels of the five panels are stacked generally parallel to each other without uncoupling the four flexible couplings; where each of the five panels have a thickness; where the five panels comprise: one middle panel having first and second sides; first and second intermediate panels flexibly coupled to the middle panel on respective first and second sides of the middle panel; first and second outermost panels flexibly coupled to respective first and second the intermediate panels to form the linearly aligned sequence; and where the middle panel includes: an external length at least as great as combined the thicknesses of the first and second outermost panels; an external length less than external lengths of each of the first and second intermediate panels and each of the first and second outermost panels; the first and second outermost panels have smaller external lengths than the respective first and second intermediate panels to which the first and second outermost panels are respectively flexibly coupled; a sixth panel, including a first side panel sized and shaped to be circumferentially engaged by the five panels; a seventh panel, including a second side panel sized and shaped to be circumferentially engaged by the five panels, where the five panels, the sixth panel, and the seventh panel comprise seven panels able to be assembled into the improved shippable speaker box; first and second aligned grooves in each panel of the five panels, where the first and second grooves are configured to receive at least a portion of the first and the second side panels, respectively where one of the sixth panel and the seventh panel includes a connector cup opening; where one of the first and second intermediate panels and the first and second outermost panels includes a speaker opening; where the five panels are able to be folded to form the speaker box by circumferentially engaging edges of the sixth and the seventh panels; and being secured thereto with an adhesive, able to adhere the sixth and seventh side panels to the five panels and/or a securer; where the five panels are able to be folded into the stacked configuration and the sixth panel and the seventh panel are able to be stacked parallel and adjacent to the five folded panels to form a stack. The improved shippable speaker box, further including a third groove across at least four panels of the seven panels, the a third groove able to receive an eighth panel, where the eighth panel is able, when the speaker box is assembled, to act as a partition interior to the speaker box. The improved shippable speaker box, combined in a kit including: the stack and a retail package containing the stack. The improved shippable speaker box, where the kit further includes: a construction element including the adhesive; hardware; and/or a set of instructions; and the securer. The improved shippable speaker box, where the securer is a bundle tie and/or an attachable alignment frame. The improved shippable speaker box, where the bundle tie includes a bundle tie lock further including a reinforced shoulder, the shoulder able to be used as a fulcrum for adjustable pliers to tighten the bundle tie circumferentially around the speaker box. The improved shippable speaker box, where the retail package has a package void and the construction element is shippable in the package void. The improved shippable speaker box, where the four flexible couplings comprise one piece of flexible fabric coupled to the five panels.

An improved shippable speaker box, including: five panels flexibly coupled in a linearly aligned sequence with four flexible couplings, where the four flexible couplings comprise one piece of flexible fabric coupled to the five panels; where the five panels are able to be folded together into a folded configuration where four panels of the five panels are stacked generally parallel to each other without uncoupling the four flexible couplings; the five linearly arranged panels comprise: one middle panel including first and second opposing sides; first and second intermediate panels flexibly coupled to the middle panel on the respective first and second opposing sides of the middle panel; first and second outermost panels flexibly coupled to respective first and second intermediate panels to form the linearly aligned sequence; and where the middle panel includes: an external length at least as great as the thicknesses of each of the first and second outermost panels combined; an external length less than external lengths of each of the first and second intermediate panels and each of the first and second outermost panels; each first and second outermost panel further including a smaller external length than the respective first and second intermediate panel to which each the first and second outermost panel is coupled; a sixth panel, including a first side panel sized and shaped to be circumferentially engaged by the five panels; a seventh panel, including a second side panel sized and shaped to be circumferentially engaged by the five panels, where the five panels, the sixth panel, and the seventh panel comprise seven panels able to be assembled into the improved shippable speaker box; where the five panels comprise first and second aligned grooves in each panel of the five panels, where the first and second aligned grooves are configured to receive a portion of the first and the second side panels, respectively, where one of the sixth panel and the seventh panel includes a connector cup opening; where one of the four panels includes a speaker opening sized, shaped, and located to receive a speaker; where the five panels are able to be folded about the flexible couplings to form the speaker box by: circumferentially engaging the sixth and the seventh panels; and being secured thereto by a securer including a bundle tie with a bundle tie lock and/or an attachable alignment frame; where the five panels are able to be folded about the flexible couplings into the folded configuration and the sixth panel and the seventh panel are able to be stacked parallel and adjacent to the five folded panels to form a stack; the stack combined in a kit further including: the securer; the connector cup; and the adhesive, able to adhere the sixth and seventh side panels to the five panels, hardware, a set of instructions, and/or a retail package. The improved shippable speaker box, further including: a eighth panel able, when the speaker box is assembled, to partition space within the assembled speaker box; and a third aligned grove across a four panels of the seven panels, able to receive at least a portion of the eighth panel.

### BRIEF DESCRIPTION OF THE DRAWINGS

The above and other objects and advantages of the present invention will become more apparent from the following description taken in conjunction with the following drawings in which:

FIG. 1 is a front perspective view illustrating some aspects of the assembled improved shippable speaker box, according to an exemplary embodiment of the present invention;

FIG. 2 is a rear perspective view illustrating additional aspects of the assembled improved shippable speaker box of FIG. 1, according to an exemplary embodiment of the present invention;

FIG. 3 is a side elevation view illustrating aspects of the assembled improved shippable speaker box of FIG. 1, according to an exemplary embodiment of the present invention;

FIG. 4 is a front perspective view illustrating some aspects of the partially assembled improved shippable speaker box of FIG. 1, according to an exemplary embodiment of the present invention;

FIG. 5 is a front perspective view illustrating some additional aspects of the partially assembled improved shippable speaker box of FIG. 1, according to an exemplary embodiment of the present invention;

FIG. 6 is a front perspective view illustrating aspects of the five-panel foldable portion of the improved shippable speaker box of FIG. 1, according to an exemplary embodiment of the present invention;

FIG. 7A is a front perspective view illustrating aspects of the five-panel foldable portion of the improved shippable speaker box of FIG. 1 in a partially folded configuration, designating detail B, according to an exemplary embodiment of the present invention;

FIG. 7B is a front perspective view illustrating detail B, from FIG. 7A, of the five-panel foldable portion of the improved shippable speaker box of FIG. 1 in a partially folded configuration, according to an exemplary embodiment of the present invention;

FIG. 8A is a front perspective view illustrating the five-panel foldable portion of the improved shippable speaker box of FIG. 1 in a further partially folded configuration, designating detail B′, according to an exemplary embodiment of the present invention;

FIG. 8B is a front perspective view illustrating detail B′, from FIG. 8A, of the five-panel foldable portion of the improved shippable speaker box of FIG. 1 in a further partially folded configuration, according to an exemplary embodiment of the present invention;

FIG. 9A is a side elevation view illustrating the improved shippable speaker box of FIG. 1 in a folded and stacked configuration, according to an exemplary embodiment of the present invention;

FIG. 9B is a side elevation view illustrating the improved shippable speaker box of FIG. 1 in a folded and stacked configuration, according to an exemplary embodiment of the present invention;

FIG. 9C is a front perspective view illustrating the improved shippable speaker box of FIG. 1 in a folded and stacked configuration, according to an exemplary embodiment of the present invention;

FIG. 10 is a rear perspective view illustrating an improved bundle tie clamp used with the improved shippable speaker box of FIG. 1, according to an exemplary embodiment of the present invention;

FIG. 11 is a diagrammatic view of a shipping kit for the improved shippable speaker box of FIG. 1, according to an exemplary embodiment of the present invention;

FIG. 12 is a front perspective view illustrating a second embodiment of the improved shippable speaker box, according to an exemplary embodiment of the present invention;

FIG. 13 is a partially unfolded view illustrating the second embodiment of the improved shippable speaker box of FIG. 12, according to an exemplary embodiment of the present invention;

FIG. 14A is a partially exploded view illustrating a securer for use with various embodiments of improved shippable speaker box, according to an exemplary embodiment of the present invention;

FIG. 14B is a cross-sectional view illustrating a channel portion of the securer of FIG. 14A, according to an exemplary embodiment of the present invention;

FIG. 14C is a cut-away view of a channel portion of the securer of FIG. 14A, according to an exemplary embodiment of the present invention;

FIG. 15 is a front perspective view illustrating the securer of FIG. 14A, 14B, and 14C in an installed position on one end of the improved shippable speaker box of FIG. 12, according to an exemplary embodiment of the present invention; and

FIG. 16 is a front perspective view illustrating a third embodiment of the improved shippable speaker box, according to an exemplary embodiment of the present invention.

### DETAILED DESCRIPTION OF THE DRAWINGS

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

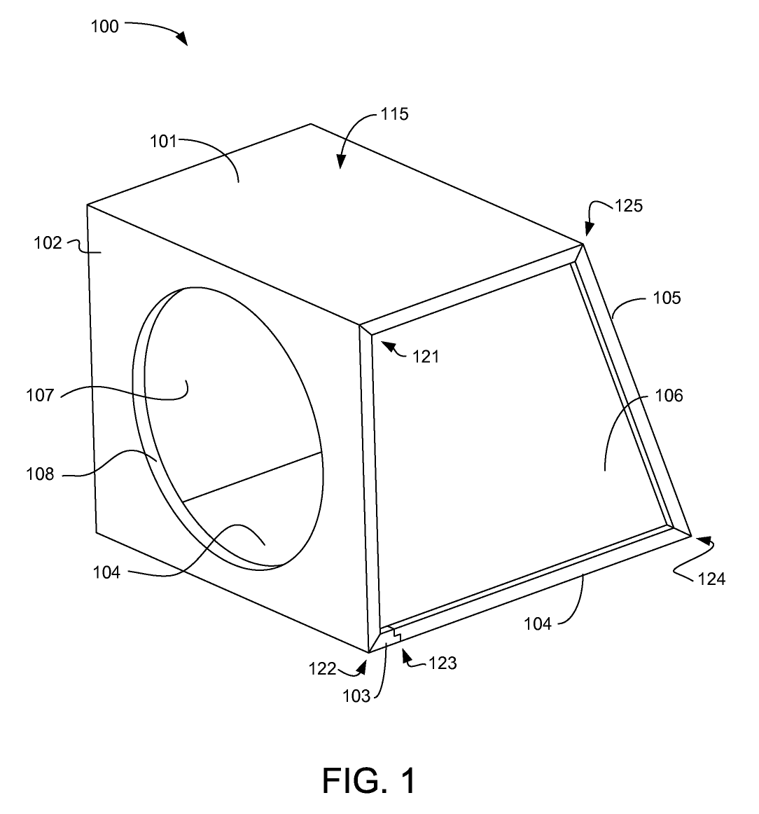

FIG. 1 is a front perspective view illustrating some aspects of the assembled improved shippable speaker box 100, according to an exemplary embodiment of the present invention. The improved shippable speaker box 100 includes a flexibly coupled set of five panels 101, 102 103, 104, and 105 in a linearly aligned sequence and first and second side panels 106 and 107. Panels 101, 102 103, 104, 105, 106 and 107 may be wood, composite, or other material. Materials with some acoustic damping properties, to reduce cabinet buzz, are preferred. Second outermost panel 101 is the top of the improved shippable speaker box 100, and is flexibly coupled at mitered joint 121 to second intermediate panel 102, which is the front panel. Second intermediate panel 102 has a speaker opening 108 for receiving a speaker. The speaker opening 108 may be associated with screw holes (not shown), or other fastener-assisting devices, to assist in mounting the speaker inside the improved shippable speaker box 100. Speaker opening 108 is shaped to compliment the speaker. The speaker is not included in this embodiment. In an alternate embodiment, the improved shippable speaker box 100 may be sold with a speaker. In yet another embodiment, the improved shippable speaker box 100 may be sold fully assembled.

Second intermediate panel 102 is flexibly coupled to short middle panel 103 at mitered joint 122. Short middle panel 103 enables stack folding of four panels 101, 102, 104, and 105 of the five panels 101, 102, 103, 104, and 105. Short middle panel 103 is flexibly coupled to bottom first intermediate panel 104 at flat mitered rabbet joint 123. Short middle panel 103 and bottom first intermediate panel 104 form the bottom of improved shippable speaker box 100. First intermediate panel 104 is flexibly coupled to first outermost panel 105, the back panel, at acutely mitered joint 124. First outermost panel 105 is joined, during assembly, as will be discussed further below, to top outermost panel 101. Preferably, the five panels 101, 102, 103, 104, and 105 are flexibly coupled by a sheet of flexible fabric 115. In various alternate embodiments, other flexible couplings may be used. With separate sheets for first and second side panels 106 and 107, fabric 115 covers the exterior surfaces of all panels 101, 102, 103 104, 105, 106, and 107. For simplicity of illustration in FIGS. 1-7A and 8A-16, the thickness of the fabric 115 is not shown. Two panels, short middle panel 103 and first intermediate panel 104, are joined with a flat rabbet joint 123 to form one bottom surface of the improved shippable speaker box 100.

First side panel 106 preferably has an isosceles trapezoidal shape and is circumferentially engaged by the five panels 101, 102, 103, 104, and 105. Four of the joints 121, 122, 124, and 125 between the five panels 101, 102, 103, 104, and 105 coincide with corners of the first side panel 106. Second side panel 107 is a mirror image of first side panel 106 and is also circumferentially engaged by the five panels 101, 102, 103, 104, and 105. When assembled together, the seven panels 101, 102, 103, 104, 105, 106, and 107 form an assembled improved shippable speaker box 100.

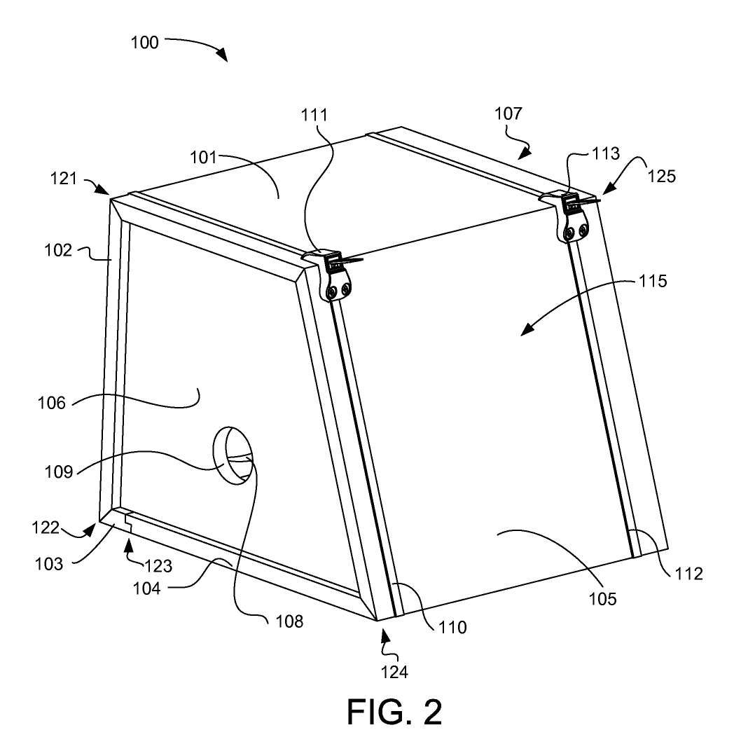

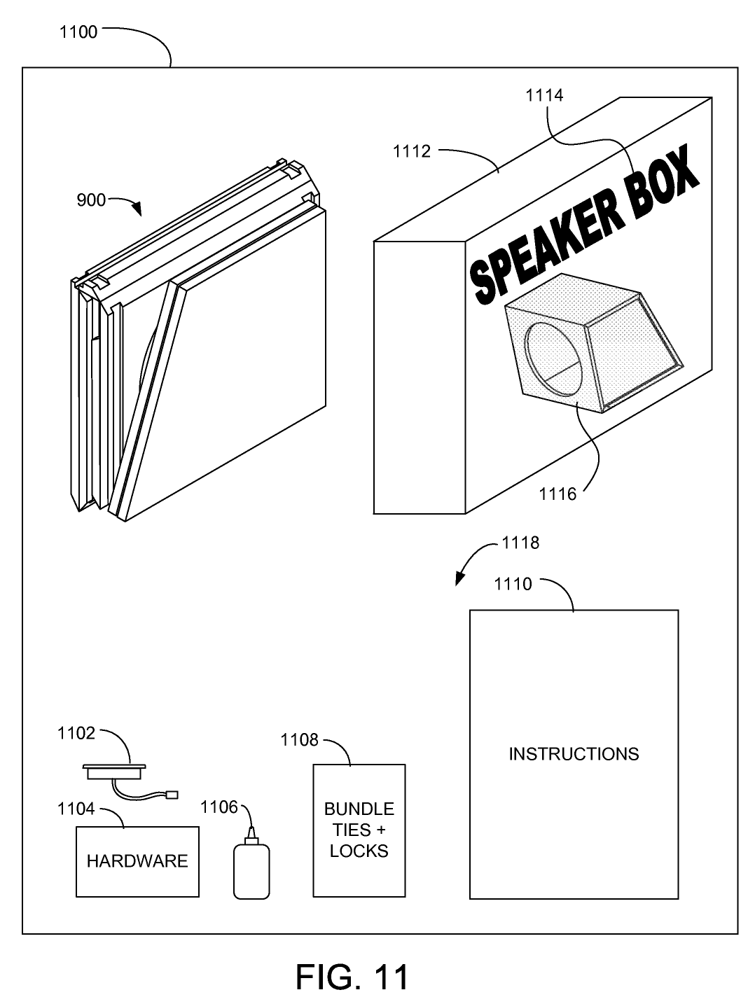

FIG. 2 is a rear perspective view illustrating additional aspects of the assembled improved shippable speaker box 100 of FIG. 1, according to an exemplary embodiment of the present invention. First side panel 106 is shown with connector cup opening 109, which receives a connector cup 1102 (see FIG. 11). Connector cup 1102 fits into connector cup opening 109 with wire leads inside the speaker box 100. The connector cup 1102 may press fit into opening 109 or may be screw mounted. Those of skill in the art, enlightened by this disclosure, will be aware of the various types and substitutes for the connector cup 1102, all of which are within the scope of the present invention. The wire leads of connector cup 1102 couple to the audio signal terminals of the speaker, when installed, and provide external terminals for an audio amplifier, or other audio signal source, in the recess of the cup, accessible from the outside of improved shippable speaker box 100.

Bundle ties 110 and 112 assist in securing the structural integrity of the improved shippable speaker box 100 after assembly. Bundle ties 110 and 112 also assist in compressing adhesive joints, to be discussed below, while the adhesive is drying, making for an improved adhesive bond. The locks, or clamps, 111 and 113 are coupled to first outermost panel 105 using fasteners that preferably extend through the fabric covering 115 and into or through first outermost panel 105. The bundle tie locks 111 and 113 are designed such that pulling a portion of the bundle tie 110 or 112 through the bundle tie lock 111 or 113, respectively, tightens the bundle tie 111 or 113, but does not allow loosening. Other parts of improved shippable speaker box 100 in FIG. 2 use the same reference numbers as FIG. 1, as will subsequent figures.

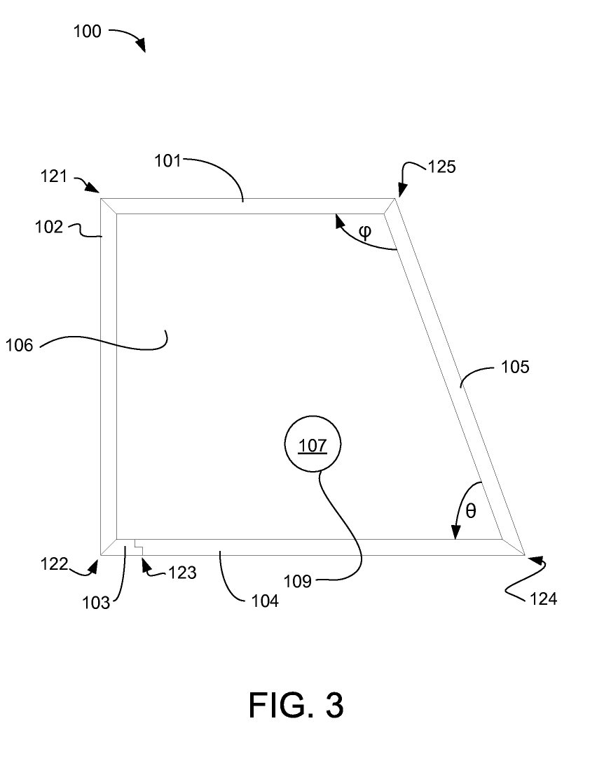

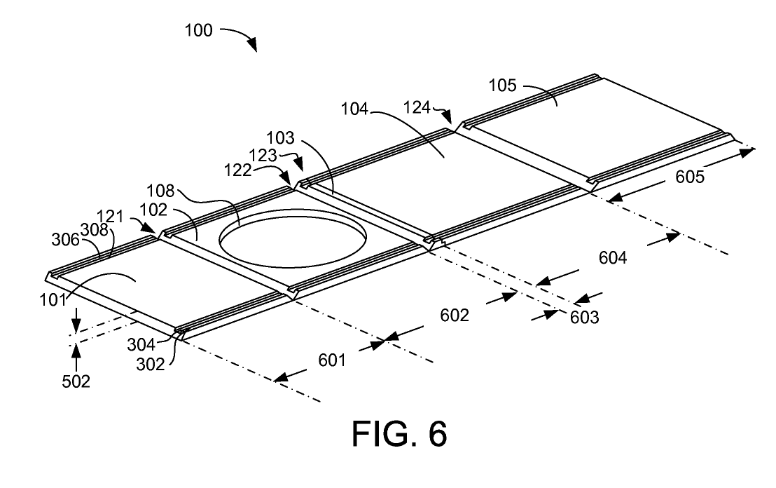

FIG. 3 is a side elevation view illustrating aspects of the assembled improved shippable speaker box 100 of FIG. 1, according to an exemplary embodiment of the present invention. Acute angle θ and obtuse angle φ are supplementary angles and define the miter angles θ and φ. The angles θ and φ may be chosen based upon acoustic principles within the constraints of folding dimensions, as discussed in more detail below. Note that the external length 604 (see FIG. 6) of first intermediate panel 104 is slightly greater than or equal to the external length 605 of first outermost panel 105, which is important to the folding scheme discussed in more detail below. It is also important that the exterior length 601 of second outermost panel 101 be no greater than the external length 602 of second intermediate panel 102.

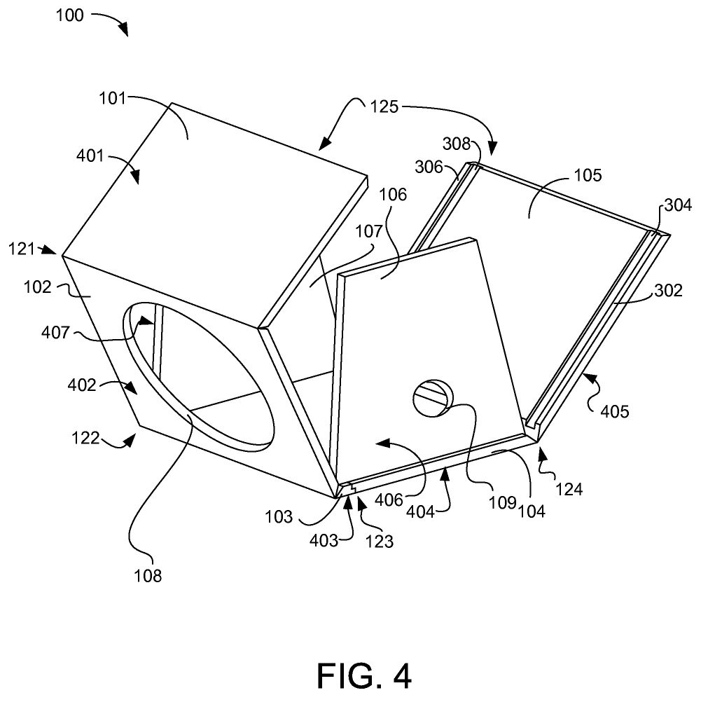

FIG. 4 is a front perspective view illustrating some aspects of the partially assembled improved shippable speaker box 100 of FIG. 1, according to an exemplary embodiment of the present invention. First and second aligned grooves 304 and 308, illustrated here as rectangular channels, but not so limited in the invention, extend in an aligned fashion into and across each of the five panels 101, 102, 103, 104, and 105. The first and second grooves 304 and 308 receive the first and second side panels 106 and 107, respectively, as first and second side panels 106 and 107 are circumferentially engaged by the five panels 101, 102, 103, 104, and 105. Groove 304 is set inward from the edge of the five panels 101, 102, 103 104, and 105 by a rim 302. Groove 308 is set inward from the edge of the five panels 101, 102, 103, 104, and 105 by a rim 306. In the present embodiment, first and second aligned grooves 304 and 308 have the same widths, but the invention is not so limited. In the present embodiment, rims 302 and 306 have the same widths, but the invention is not so limited.

Acutely mitered joint 124 and mitered joint 122 are shown open, and illustrate that the groove 304 extends the full length of panel 105, 104, and 103, as well as panels 102 and 101 (not visible in this view). Mitered joint 125 is open and is shown as two surfaces, but is not flexibly coupled by fabric 115. Rather, joint 125 is fastened during assembly. External surfaces 401, 402, 403, 404, 405, 406, and 407 of panels 101, 102, 103, 104, 105, 106, and 107, respectively, are identified for reference in discussions below.

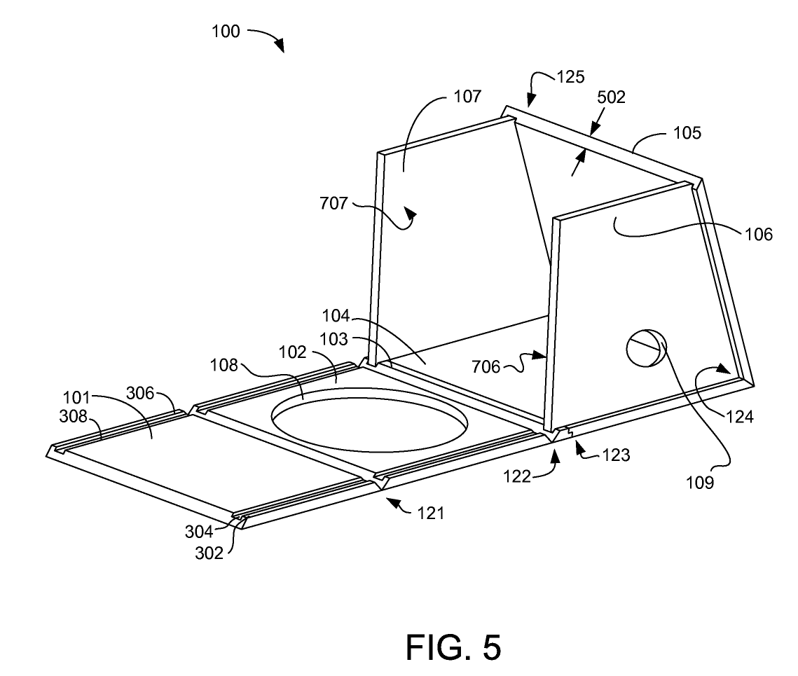

FIG. 5 is a front perspective view illustrating some additional aspects of the partially assembled improved shippable speaker box 100 of FIG. 1, according to an exemplary embodiment of the present invention. First and second aligned grooves 304 and 308 are shown in second outermost panel 101 and second intermediate panel 102, and can be partially seen in middle panel 103. Likewise, rims 302 and 306 are shown in second outermost panel 101 and second intermediate panel 102, and can be partially seen in middle panel 103. The depth of first and second aligned grooves 304 and 308 is preferably less than one-half the thickness 502 of a panel 101, 102, 103, 104, or 105. Panels 101, 102, 103, 104, or 105 preferably all have the same panel thickness 502, but the invention is not so limited. Internal surface 706 of panel 106 and internal surface 707 of panel 107 are identified for reference in discussions below.

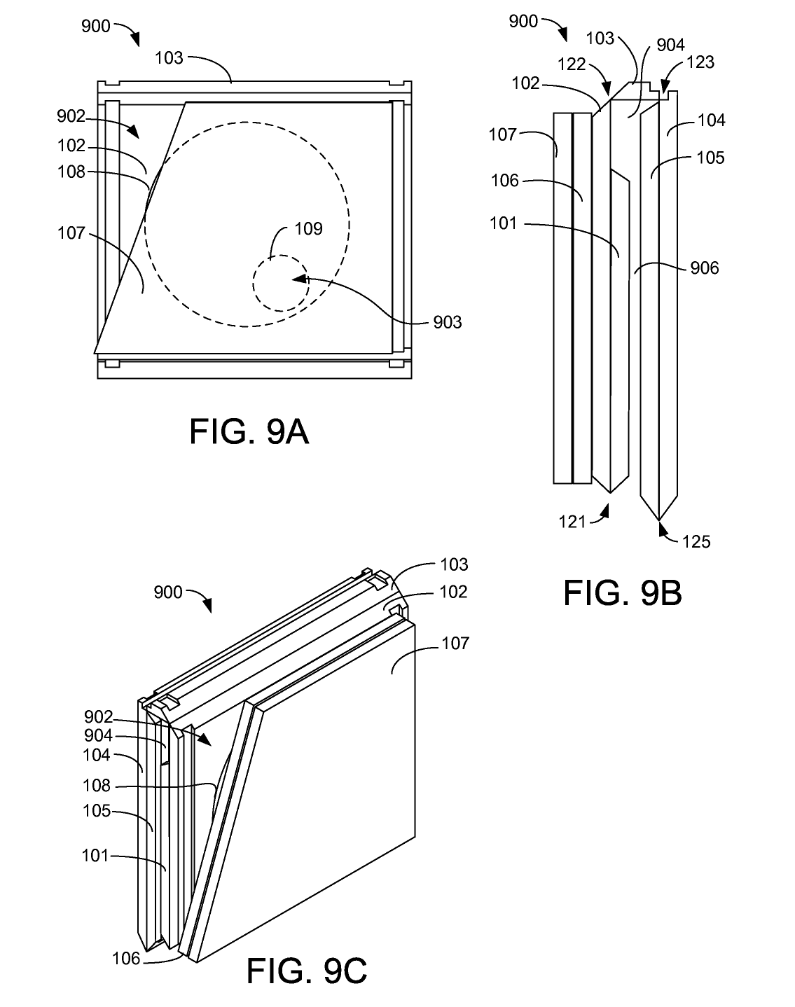

The speed of assembly is greatly improved by having the five panels 101, 102, 103, 104, and 105 coupled together in a linearly aligned sequence that can be unfolded from the shipping stack 900 (see FIG. 9) and quickly refolded around the circumferences of the first and second side panels 106 and 107. The joints 121, 122, 123, 124, and 125 properly align without special effort due to the combination of first and second aligned grooves 304 and 308 with the flexible coupling of the fabric 115.

In the stage of assembly illustrated in FIG. 5, panels 103, 104, and 105 have been engaged on the circumference of panels 106 and 107. Preferably, adhesive 1106 (see FIG. 11) is applied in the first and second aligned grooves 304 and 308 before the first and second panels 106 and 107 are engaged. Adhesive 1106 is preferably also applied to the joints 121, 122, 123, 124, and 125, as improved shippable speaker box 100 is assembled. Care should be taken not to overuse the adhesive 1106, as leakage to the outside may mar the appearance of the improved shippable speaker box 100. Those of skill in the art, enlightened by this disclosure, will appreciate the various adhesives 1106 appropriate for this application, and its dependency on the type of panel materials. In an alternate embodiment, the adhesive 1106 may be a two-sided adhesive tape. In yet another embodiment, the adhesive 1106 may be an elastomeric adhesive tape that provides damping and adhesion. In still yet another embodiment, an acoustic damping material may be adhered into first and second aligned grooves 304 and 308, and then first and second side panels 106 and 107 may be adhered to the acoustic damping materials in the first and second aligned grooves 304 and 308.

FIG. 6 is a front perspective view illustrating aspects of the five-panel 101, 102, 103, 104, and 105 foldable portion of the improved shippable speaker box 100 of FIG. 1, according to an exemplary embodiment of the present invention. The panels 101, 102, 103, 104, and 105 are shown with their interior surfaces up. The panels 101, 102, 103, 104, and 105 are constructed in a linearly aligned sequence, and first aligned groove 304 and second aligned groove 308 are likewise aligned across panels 101, 102, 103, 104, and 105. The alignment of panels 101, 102, 103, 104, and 105 is maintained by fabric 115 (on exterior surfaces, not visible in this view). Carpet is a preferred fabric 115, but the invention is not so limited. Other fabric 115 may be used, such as leather, padded fabrics, chain mail, and the like. Other approaches to flexible couplings may be used. In a physically demanding embodiment, piano hinges may be used, preferably with acoustic damping in the joints 121, 122, 123, and 124.

The view of FIG. 6 is the view of the five panels 101, 102, 103, 104, and 105 as they come off the assembly line in a linearly aligned sequence. Initially one piece of main panel material, the main panel is cut to size, first and second aligned grooves 304 and 308 are cut into the remaining panel, and the angled mitered joints 121, 122, 124, and 125, as well as the rabbet joint 123, of panel 104 are cut. The short middle panel 103 is cut and mitered for the angled miter joint 122 on one end and the flat rabbet joint 123 on the other. The panels 101, 102, 103, 104, and 105 are aligned and the fabric 115 is applied. In an alternative embodiment, without the rabbet joint 123, the fabric 115 is applied after the main panel material is cut.

Short middle panel 103 has two opposite sides for coupling first and second intermediate panels 104 and 102. Short middle panel 103 is flexibly coupled to first intermediate panel 104 using a flexibly coupled flat rabbet joint 123. First intermediate panel 104 is flexibly coupled to first outermost panel 105 using a flexibly coupled mitered joint 124. Short middle panel 103 is flexibly coupled to second intermediate panel 102 using a flexibly coupled mitered joint 122. Second intermediate panel 102 is flexibly coupled to second outermost panel 101 using a flexibly coupled mitered joint 121. The four flexible couplings 121, 122, 123, and 124 are preferably made by affixing a single sheet of fabric 115 over the surfaces of the improved shippable speaker box 100 that will become exterior surfaces after assembly. Carpet is an acceptable fabric 115 for such flexible couplings 121, 122, 123, and 124, but the invention is not limited to carpet.

External lengths 601, 602, 603, 604, and 605 of panels 101, 102, 103, 104, and 105, respectively, and panel thickness 502 have important relationships. Preferably, the thickness 502 of panels 101, 102, 103, 104, and 105 are the same, but the invention is not so limited. The length 603 of middle panel 103 must be at least as great as the combined thicknesses 502 of the first and second outermost panels 101 and 105. Preferably, the length 603 of middle panel 103 is slightly longer than the necessary minimum of the combined thicknesses 502 of the first and second outermost panels 101 and 105. If the relationship between the length 603 of the middle panel 103 and the combined thicknesses 502 of the first and second outermost panels 101 and 105 does not comply with the requirement stated, stacking panels 101, 102, 104, and 105 with four flexible couplings 121, 122, 123, and 124 intact will be impossible. If fabric 115 has a significant thickness, this thickness must be accounted for in determining the exterior length 603 of panel 103.

Length 601 of second outermost panel 101 must be no longer than, and is preferably slightly less than, the length 602 of adjacent second intermediate panel 102. Likewise, length 605 of first outermost panel 105 must be no longer than, and is preferably slightly less than, the length 604 of adjacent first intermediate panel 104. If the size relationship between first and second intermediate panels 102, 104, and their respective flexibly coupled first and second outermost panels 101, 105 is not enforced, stacking the panels 101, 102, 104, and 105 with the flexible couplings intact will be impossible.

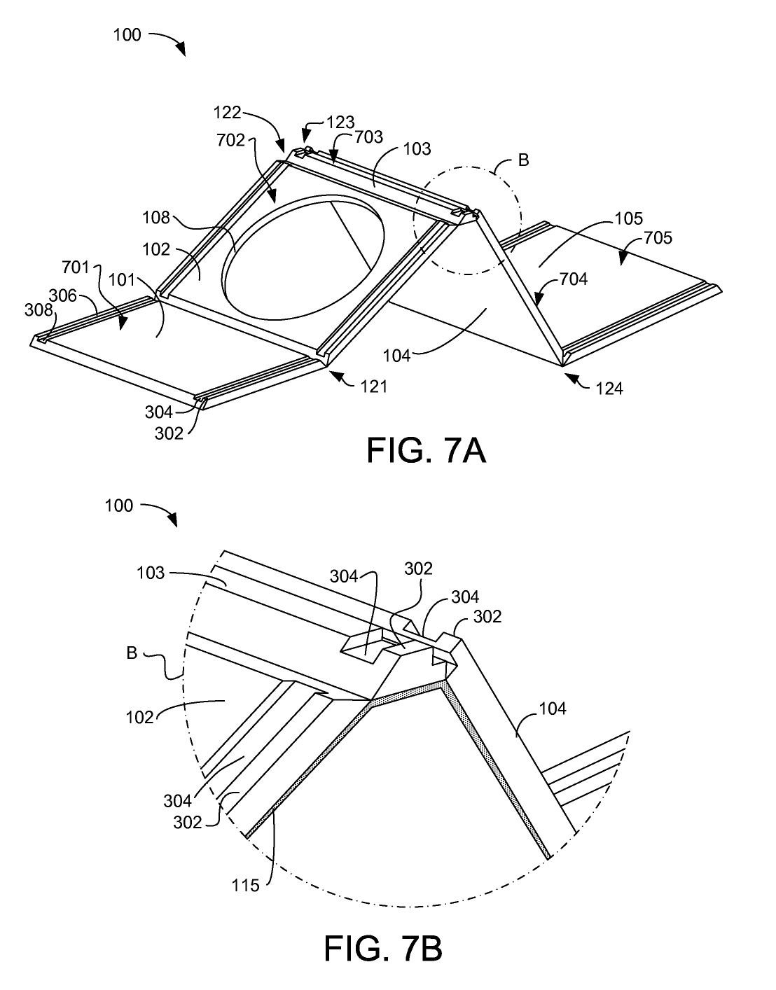

FIG. 7A is a front perspective view illustrating aspects of the five-panel 101, 102, 103, 104, and 105 foldable portion of the improved shippable speaker box 100 of FIG. 1 in a partially folded configuration, designating detail B, according to an exemplary embodiment of the present invention. In a first stage of folding for shipping, panels 101, 102, 103, 104, and 105 are raised by the short middle panel 103. Internal surfaces 701, 702, 703, 704, and 705 of panels 101, 102, 103 104, and 105, respectively, are identified for reference in discussions below.

FIG. 7B is a front perspective view illustrating detail B, from FIG. 7A, of the five-panel 101, 102, 103, 104, and 105 foldable portion of the improved shippable speaker box 100 of FIG. 1 in a partially folded configuration, according to an exemplary embodiment of the present invention. Detail B shows the flexing of the rabbet joint 123 between short middle panel 103 and bottom first intermediate panel 104 and the flexing of mitered joint 122 between short middle panel 103 and second intermediate panel 102. The layer of fabric 115 is in better view in detail B.

The flat rabbet joint 123 is a preferred joint that can be rotated at one outer edge. In a lesser preferred embodiment, a flat butt joint may be used, which simplifies manufacture (simple saw cut) but reduces structural stability. In a yet lesser preferred embodiment, a mitered joint, similar to joints 121 and 122, may be used, which simplifies manufacture (using the same router tool to make all mitered joints) but reduces structural stability even more, and requires cosmetic compensation to deal with the notch left on the exterior rim at the joint between short middle panel 103 and bottom first intermediate panel 104. The flat rabbet joint 123 is more complex to manufacture but gives excellent structural integrity and requires no cosmetic compensation.

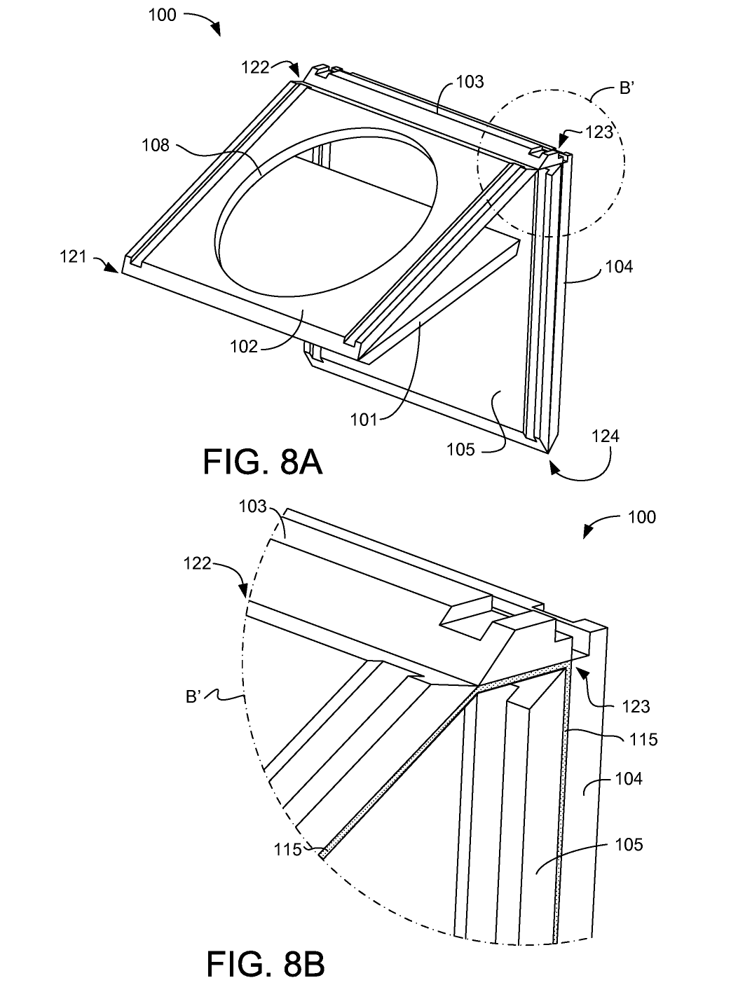

FIG. 8A is a front perspective view illustrating the five-panel 101, 102, 103, 104, and 105 foldable portion of the improved shippable speaker box 100 of FIG. 1 in a further partially folded configuration, designating detail B′, according to an exemplary embodiment of the present invention. First intermediate panel 104 and first outermost panel 105 are folded to a folded configuration in which they are parallel and adjacent to one another. This illuminates the point that the length 603 of short middle panel 103 is chosen, in part, to make a foldable size relationship between first intermediate panel 104 and first outermost panel 105. If the length 605 of first outermost panel 105 is longer than the length 604 of first intermediate panel 104, then the folding shown in FIG. 8A would fail, as the outer edge of the first outermost panel 105 would impact middle panel 103. The same situation applies in regard to second intermediate panel 102 being at least as long as second outermost panel 101 for successful folding. The external lengths 603, 604, and 605 of panels 103, 104, and 105, respectively, should be predetermined to allow back first outermost panel 105 to fold to a position adjacent and parallel to bottom first intermediate panel 104. If short middle panel 103 is too long, first intermediate (bottom) panel 104 may be shorter than first outermost (back) panel 105 (holding the length of the bottom of the speaker box, as assembled, constant), preventing first outermost panel 105 from folding into the position shown. Accordingly, the external length 603 of short middle panel 103 should be selected to make first intermediate panel 104 longer than first outermost panel 105. It should further be appreciated that the angles θ and φ, if not determined in light of folding constraints, may result in external lengths 605 and 604 of first outermost panel 105 and first intermediate panel 104, respectively, that are inconsistent with successful folding.

Second outermost (top) panel 101 is partially folded under second intermediate (front) panel 102. It can be seen that the external length 601 of second outermost panel 101 must be less than the external length 602 of second intermediate panel 102 for the fold to be ultimately successful. Note that the panels 101 and 102 as well as panels 104 and 105 have their external surfaces 401 and 402 adjacent, as well as external surfaces 404 and 405 adjacent. Their internal surfaces 701, 702, 703, 704 and 705, ultimately hidden after assembly, are outward to receive any blemishes that may accrue during handling and shipping. In a particular embodiment where the fabric 115 is particularly subject to blemishes by rubbing, such as with a glossy polymeric fabric, a protective sheet may be inserted between the adjacent panels 101 and 102, or between adjacent panels 104 and 105 during shipping.

FIG. 8B is a front perspective view illustrating detail B′, from FIG. 8A, of the five-panel 101, 102, 103, 104, and 105 foldable portion of the improved shippable speaker box 100 of FIG. 1 in a further partially folded configuration, according to an exemplary embodiment of the present invention. Detail B′ shows flat mitered rabbet joint 123 open at 90 degrees of angle. Second outermost panel 105 is folded to have its external surface 405, covered by fabric 115, adjacent to the external surface 404, also covered by fabric 115, of second intermediate panel 104. FIG. 8B illuminates that the exterior length 603 of short middle panel 103 must be at least two times thickness 502, including fabric 115, in addition to other constraints.

FIG. 9A is a side elevation view illustrating the improved shippable speaker box 100 of FIG. 1 in a folded and stacked configuration, according to an exemplary embodiment of the present invention. The stack 900 includes the five panels 101, 102, 103, 104, and 105, and the first and second side panels 106 and 107. The advantage of having side panels 106 and 107 no larger in length and width than the largest of the top, front, bottom, and back panels 101, 102, 104, and 105, as shown, is that the first and second side panels 106 and 107 do not make the stack 900 any larger in length or width.

The internal surface 702 of second intermediate panel 102 is preferably adjacent to internal surface 706 of the second intermediate panel 106, such that the speaker opening 108 and the connector cup opening 109 form a stack void 903, in which some construction elements (not likely to mar external surface 707) for the improved shippable speaker box 100 may be shipped. Second side panel 107, with its external surface 407 adjacent to external surface 706 of second intermediate panel 106, closes the stack void 903 and maintains an internal surface 707 on the exterior of the stack 900. A box void 902 is formed which may be used for shipping construction elements with the stack 900 in a rectangular box. Note that, to get the sloped portions of first and second side panels 106 and 107 to line up, either the external surfaces 406 and 407 must be adjacent or the internal surfaces 706 and 707 must be adjacent. The clear preference is for external surfaces 406 and 407 to be adjacent and protected, while the ultimately hidden internal surface 707 is on the exterior of the stack 900.

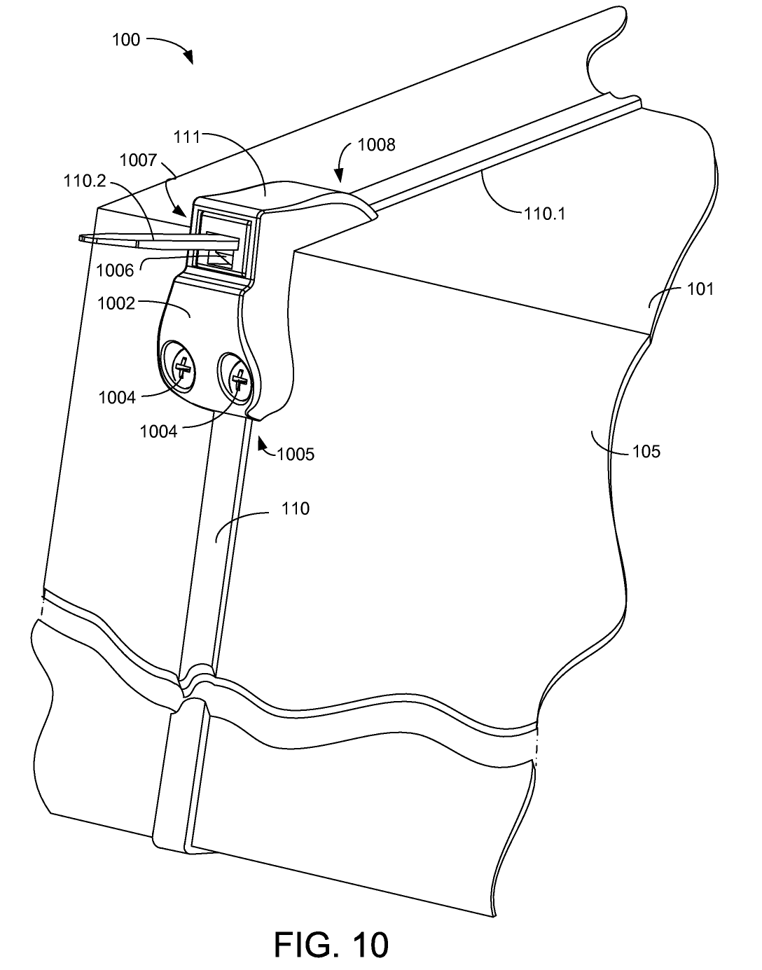

FIG. 9B is a side elevation view illustrating the improved shippable speaker box 100 of FIG. 1 in a folded and stacked configuration, according to an exemplary embodiment of the present invention. Two additional stack voids, 904 and 906 become apparent in this view. Stack void 906 may accommodate a set of instructions 1110 (se FIG. 10), while stack void 904 may accommodate bundle ties 110 and 113 with bundle tie locks 111 and 113, respectively, for shipping. In the most preferred embodiment, all of the construction elements are shipped in box voids, such as box void 902. At the point where the retail package for the product is filled, the stack 900 may already be bundled or shrink-wrapped, and so use of stack voids 903, 904, and 906 may not always be possible.

FIG. 9C is a front perspective view illustrating the improved shippable speaker box 100 of FIG. 1 in a folded and stacked configuration, according to an exemplary embodiment of the present invention. The short middle panel 103 must be the middle of the five panels 101, 102, 103, 104, and 105. In various alternate embodiments, the location of the short middle panel 103 may be re-arranged so that the short middle panel 103, instead of being coplanar with the bottom first intermediate panel 104, is coplanar with any one of the second outermost panel 101, second intermediate panel 102, or first outermost panel 105 as long as the assembly joint (125, in the illustrated embodiment) is the third joint away from the short middle panel 103 in both directions. This leaves two foldable panels on each side of the short middle panel 103, and the folding approach of the present invention may be used, as long as the relative length constraints, previously mentioned, are maintained.

FIG. 10 is a rear perspective view illustrating an improved bundle tie lock 111 used with the improved shippable speaker box 100 of FIG. 1, according to an exemplary embodiment of the present invention. Bundle tie lock 111 is fastened to first outermost panel 105 using fasteners 1004, which are accommodated by the lock 111 design. A first end of bundle tie 110 is fixed in the lock 111 and extends through end 1005 via an opening or notch. Bundle tie 110 extends around the speaker box 100 and has a lockable portion 110.1 which extends into an opening or notch in second end 1008 and threads through the internal locking mechanism 1006. A short extension 110.2 extends out of lock opening 1007.

Shoulder 1002 is reinforced underneath to make it operable as a fulcrum. In a preferred method of assembly, a pair of adjustable pliers is held with the jaws downward and grasping the tab 110.2. Thus, what would normally be the top jaw of the adjustable pliers is engaged with the underside of tab 110.2 and the outside of the jaw is resting on shoulder 1002. By clamping tab 110.2 tightly with the adjustable pliers and prying against shoulder 1002 to pull the tab 110.2 out of the lock 111, the bundle tie 110 can be tightened to a very high degree. After assembly, excess tab 110.2 may be trimmed away by any convenient means. Preferably, bundle tie 110 is tightened before any adhesive used to adhere the side panels 106 and 107 sets. In an alternate embodiment, where the option to disassemble the improved shippable speaker box 100 is desired, the adhesive may be omitted and tab 110.2 not trimmed (for reuse later). The lock may be released, albeit with some difficulty, by depressing lock 1006 away from bundle tie 110.1 with a small rigid tool, such as an ice pick or a screwdriver. For alternate embodiments that will be frequently deconstructed and reconstructed, such as those for concert touring, a more readily releasable lock is preferred.

Bundle ties 110 and 112 may be above fabric 115, as shown in FIG. 2, or may be underneath the fabric 115 for all portions except tab 110.2. If not below the fabric 115, the bundle ties 110 and 112 may be decorative. For example, and without limitation, bundle ties 110 and 112 may be colored, metallic, pearlescent, clear, may include a design, or may include inclusions in a non-opaque substrate. In an alternate embodiment, only one bundle tie 110 may be used. In various alternate embodiments, more than two bundle ties 110 and 112 may be used.

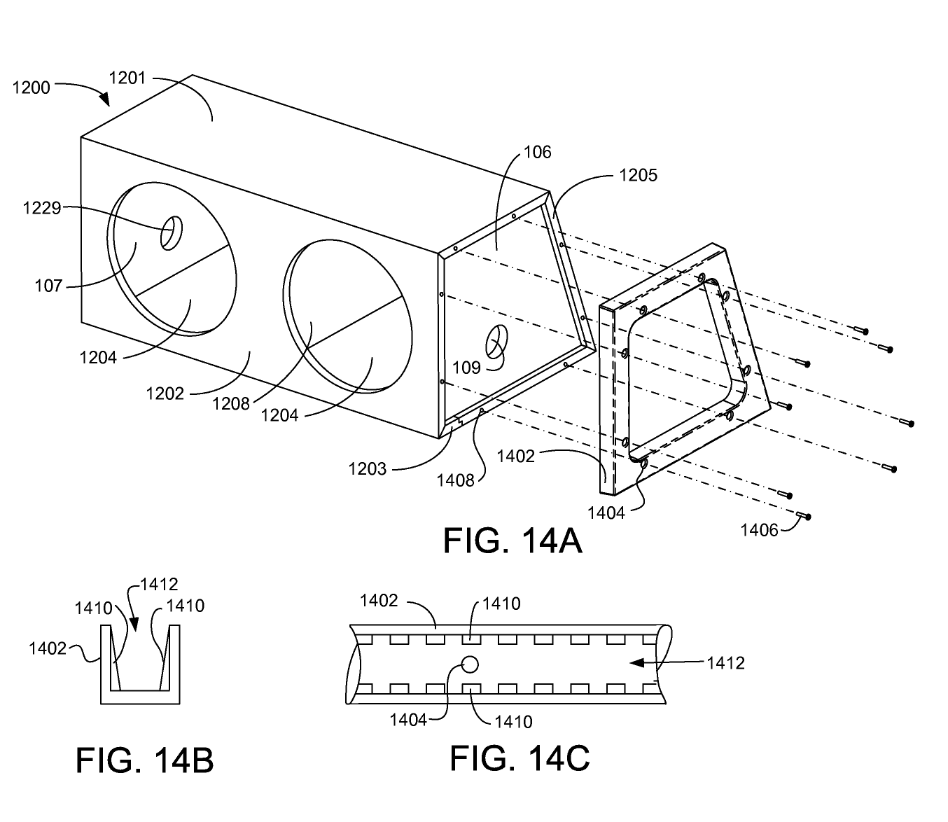

FIG. 11 is a diagrammatic view of a shipping kit 1100 for the improved shippable speaker box 100 of FIG. 1, according to an exemplary embodiment of the present invention. Kit 1100 includes a stack 900, construction elements 1118 for assisting in assembly, and may include a retail package 1112. Construction elements 1118 may include a connector cup 1102, an adhesive 1106, a package 1108 containing bundle ties 110 and 112 with bundle tie locks 111 and 113, or other securer (See FIG. 14A) and a set of instructions 1110. The set of instructions 1110 may include instructions in multiple languages. The adhesive 1106 may be of any type or form appropriate for the materials being adhered. The preferred bundle ties 110 and 112 with bundle tie locks 111 and 113 are illustrated in FIG. 2 and FIG. 10. Optional hardware package 1104 may include fasters 1004, or fasters 1004 may be included in package 1108. If mounting hardware is used with a particular embodiment, such as to mount the improved shippable speaker box 100 to a wall or ceiling, that hardware may be included in hardware package 1104. In a preferred embodiment, the fasteners 1004 are packaged with the bundle ties 110 and 112 with bundle tie locks 111 and 113 and there is no package 1104. In an alternate embodiment, all or part of the set of instructions may be printed on one or more interior surfaces 701, 702, 703,704, 705, 706, and/or 708. If the stack 900 is not bound or shrink-wrapped at the kit 1100 assembly point, at least some of the construction elements 1118 may be packed in stack voids 903, 904, and 906. In a preferred embodiment, construction elements may be packed in box voids, such as box void 902.

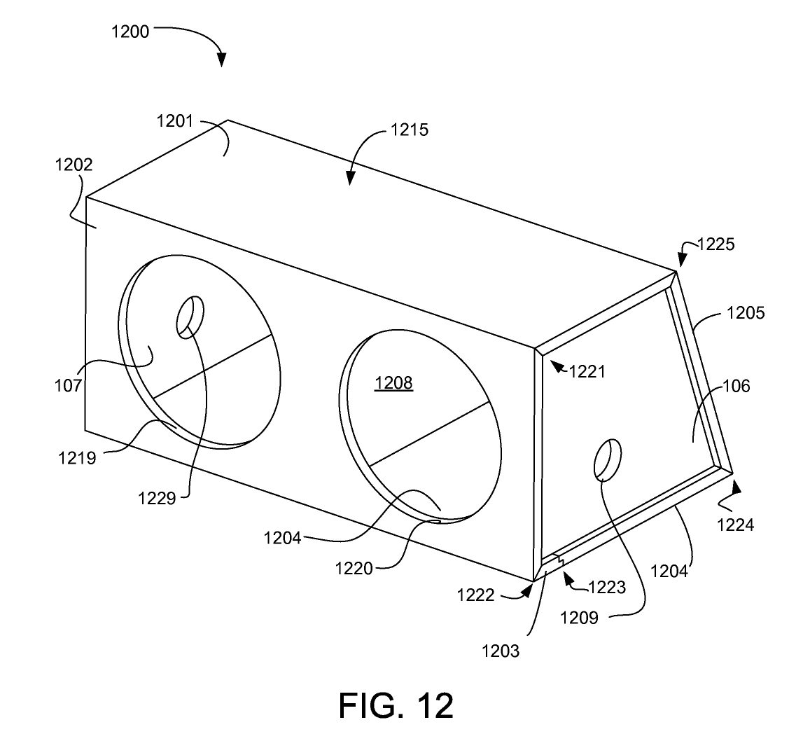

FIG. 12 is a front perspective view illustrating a second embodiment of the improved shippable speaker box 1200, according to an exemplary embodiment of the present invention. Improved shippable speaker box 1200 has two speaker openings 1219 and 1220 in panel 1202. Improved shippable speaker box 1200 comprises a short middle panel 1203, first and second intermediate panels 1204 and 1202, and first and second outermost panels 1205 and 1201 flexibly coupled in a linearly aligned sequence. Short middle panel 1203 is flexibly coupled on a first side to first intermediate panel 1204 using a flexibly coupled flat rabbet joint 1223. First intermediate panel 1204 is flexibly coupled to first outermost panel 1205 using a flexibly coupled mitered joint 1224. Short middle panel 1203 is flexibly coupled on a second side to second intermediate panel 1202 using a flexibly coupled mitered joint 1222. Second intermediate panel 1202 is flexibly coupled to second outermost panel 1201 using a flexibly coupled mitered joint 1221. The four flexible couplings at joints 1221, 1222, 1223, and 1224 are preferably made by affixing a single sheet of fabric 115 over the surfaces of the improved shippable speaker box 1200 that will become exterior surfaces after assembly. The five panels 1201, 1202, 1203, 1204, and 1205 and the four flexible couplings at joints 1221, 1222, 1223, and 1224 form the foldable portion of improved shippable speaker box 1200. Together with first and second side panels 106 and 107, the five panels 1201, 1202, 1203, 1204, and 1205 and the four flexible couplings at joints 1221, 1222, 1223, and 1224 form the improved shippable speaker box. Carpet is an acceptable fabric for such flexible couplings at joints 1221, 1222, 1223, and 1224, but the invention is not limited to carpet.

Partition 1208, an eighth panel, partitions the space inside improved shippable speaker box 1200 into two separate chambers: one for each speaker opening 1219 and 1220. Preferably, each chamber has a connector cup opening 1209, 1229, though the invention is not so limited. Those of skill in the art, enlightened by the present disclosure, will appreciate the vast number of variations of partitions 1208 of the internal spaces in the improved shippable speaker box 1200 that may be made. For example, addition of horizontal partitions might be used with eighth panel 1208 to create four chambers for four speaker openings. In another alternate embodiment, each chamber may have more than one speaker opening 1219, 1220. Very large improved shippable speaker boxes 1200 may be made for rock concert applications or complex speaker arrangement.

Panels 1201, 1202, 1203, 1204, and 1205 are longer than their counterparts in improved shippable speaker box 100. Flexible joints 1221, 122Third2, 1223, 1224, and 1225 are similar in cross section to their counterparts in improved shippable speaker box 100 but are longer to accommodate the longer panels 1201, 1202, 1203, 1204, and 1205.

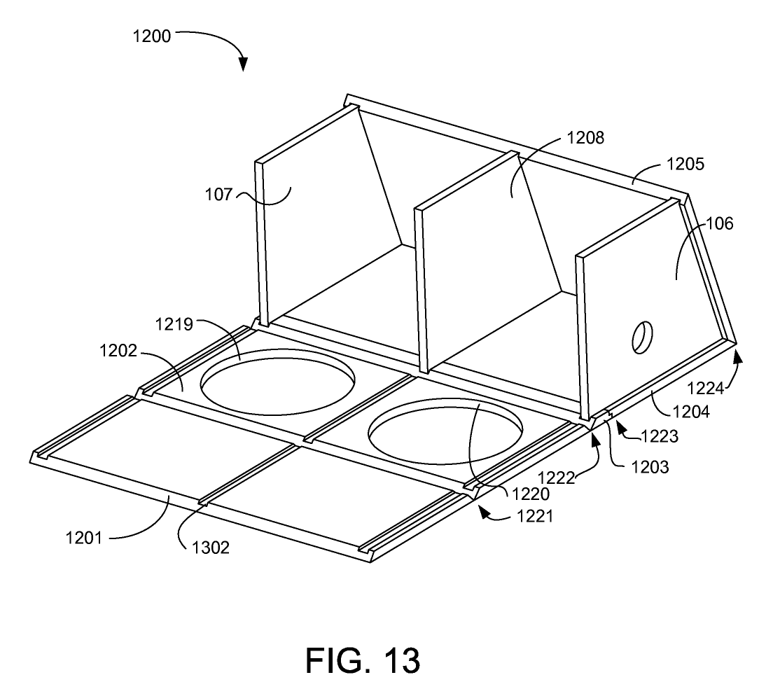

FIG. 13 is a partially unfolded view illustrating the second embodiment of the improved shippable speaker box 1200 of FIG. 12, according to an exemplary embodiment of the present invention. Third (central) aligned groove 1302 crosses panels 1201, 1202, 1203, 1204, and 1205 and receives portions of partition 1208 to assist in acoustically separating the two chambers. Partition 1208 is preferably stacked on the outside of the shipping stack, such as stack 900, because any damage to its surface during shipping will not be visible after assembly. In an alternate embodiment having a horizontal partition, an aligned groove through at least four panels. In an another alternate embodiment, a partition engaging grooves in three panels may be employed.

FIG. 14A is a partially exploded view illustrating a securer 1402 for use with various embodiments of improved shippable speaker box 100, 1200, according to an exemplary embodiment of the present invention. Securer 1402, an attachable alignment frame, may be used as an alternative to bundle ties, or securers, 110 and 112. Securer 1402 includes a shaped channel 1412 (see FIG. 14B) fashioned to overlie the ends of panels 1201, 1202, 1203, 1204, and 1205. Holes 1404 (one of eight labeled) in the attachable alignment frame 1402 align to holes 1408 (one of eight labeled) in panels 1201, 1202, 1204, and 1205 to receive screws 1406 (one of eight labeled). The interior of the channel 1412 of securer 1402 is shaped to the preferred position of the edges of panels 1201, 1202, 1203, 1204, and 1205 of the improved shippable speaker box 1200. As screws 1406 are tightened, each edge of panels 1201, 1202, 1203, 1204, and 1205 is urged into correct position by the channel 1412 walls. It should be obvious to those of skill in the art, enlightened by this disclosure, that the securer 1402 will work with embodiments 100 or 1200, and that variation in size and shape to accommodate any of the claimed inventive embodiments is possible.

FIG. 14B is a cross-sectional view illustrating a channel portion of the securer 1402 of FIG. 14A, according to an exemplary embodiment of the present invention. Beveled protrusions 1410 in the channel 1412 of securer 1402 urge the edges of panels 1201, 1202, 1203, 1204, and 1205 to the center of the channel 1412, representing the preferred position of the edges of panels 1201, 1202, 1203, 1204, and 1205.

FIG. 14C is a cut-away view of a channel portion of the securer 1402 of FIG. 14A, according to an exemplary embodiment of the present invention. The beveled protrusions 1410 are preferably not entire along the length of channel 1412, but are divided into segments spaced-apart along the channel 1412, as shown. The beveled protrusions 1410 may be opposed on opposite sides of channel 1412, as shown, or alternated. Screw holes 1404 are preferably centered in the channel 1412.

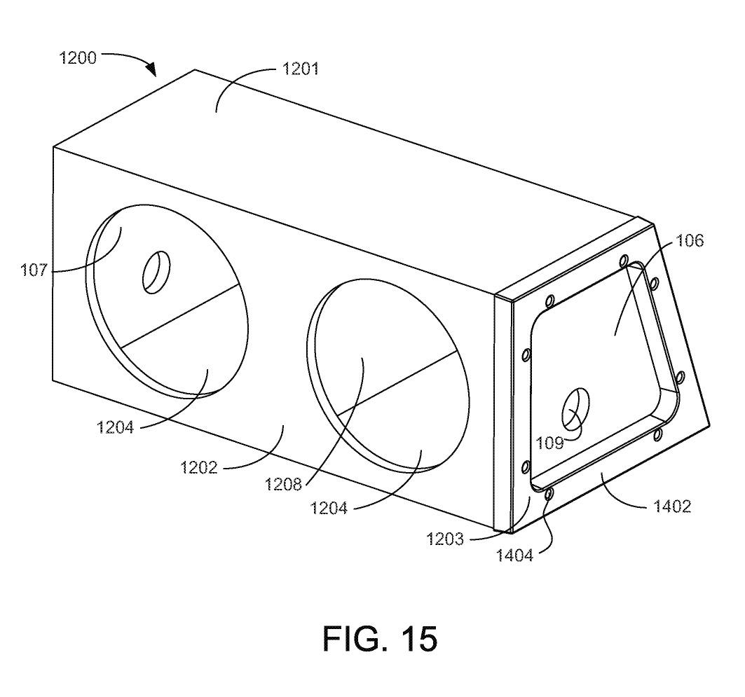

FIG. 15 is a front perspective view illustrating the securer 1402 of FIG. 14A, 14B, and 14C in an installed position on one end of the improved shippable speaker box 1200 of FIG. 12, according to an exemplary embodiment of the present invention. In a preferred embodiment, two securers 1402 are used: one at each end of improved shippable speaker box 1200. When improved shippable speaker box 1200 is shipped, both end panels 106 and 107 may be placed side-by-side on panel 1202 to form two stack voids, such as stack void 903 in FIG. 9A.

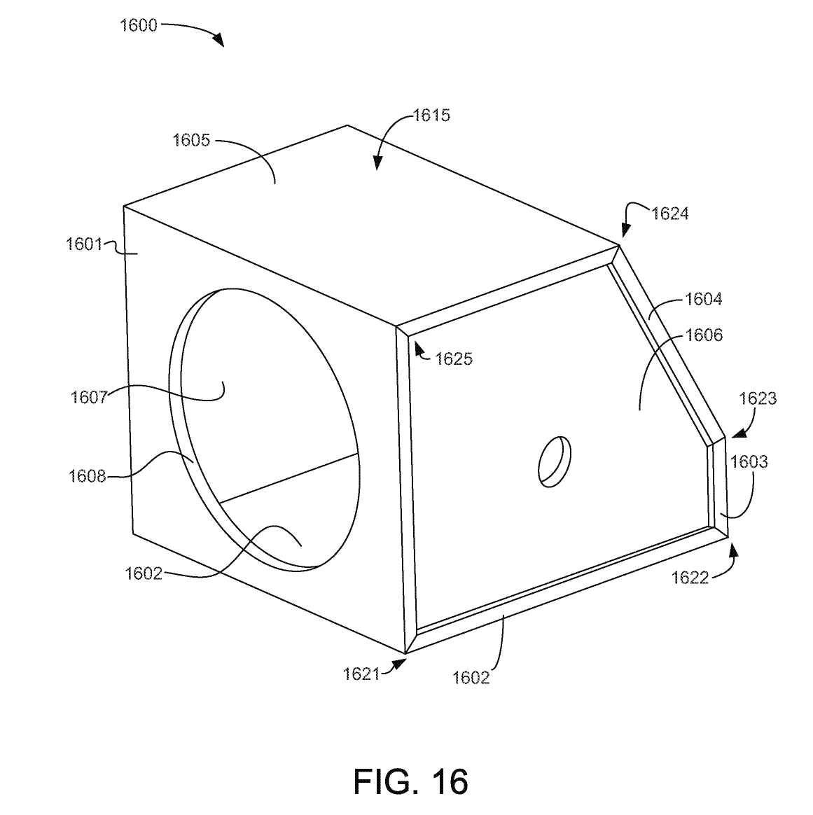

FIG. 16 is a front perspective view illustrating a third embodiment of the improved shippable speaker box 1600, according to an exemplary embodiment of the present invention. Note the renumbering of the panels 1601, 1602, 1603, 1604, and 1605 to indicate the middle panel 1603 as the non-parallel panel in the stack (See FIG. 9A,-9C). Middle panel 1603 is flexibly coupled, on a first side, to first intermediate panel 1604 at flexibly coupled joint 1623. First outermost panel 1605 is flexibly coupled to first intermediate panel 1604 at flexibly coupled joint 1624. Middle panel 1603 is flexibly coupled, on a second side, to second intermediate panel 1602 at flexibly coupled joint 1622. Second outermost panel 1601 is flexibly coupled to second intermediate panel 1602 at flexibly coupled joint 1621. First and second outermost panels 1601 and 1605 meet, during assembly, at joint 1625. Joints 1621, 1622, 1623, and 1624 are preferably made rigid with adhesive 1106 and securers 110, 112, and/or 1402 during assembly, and are flexible for production and shipment.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims, as interpreted in light of the specification and the legal equivalents thereof.

What is claimed is:

1. An improved shippable speaker box, comprising:
a) five panels flexibly coupled in a linearly aligned sequence with four flexible couplings, comprising:
i. a middle panel comprising four sides;
ii. first and second intermediate panels, each flexibly coupled to said middle panel on one of two opposite sides of said four sides, in said linearly aligned sequence;
iii. first and second outermost panels, each flexibly coupled to one respective said intermediate panel in said linearly aligned sequence;
iv. said five panels operable to be folded together into a configuration where said first and second intermediate panels and said first and second outermost panels are stacked generally parallel to each other without uncoupling said four flexible couplings;
b) a sixth panel, comprising a first side panel sized and shaped to be circumferentially engaged by said five panels;
c) a seventh panel, comprising a second side panel sized and shaped to be circumferentially engaged by said five panels, wherein said five panels, said sixth panel, and said seventh panel comprise seven panels operable to be assembled into said improved shippable speaker box.

2. The improved shippable speaker box of claim 1, further comprising at least one eighth panel operable in assembly of said speaker box to partition space interior to said speaker box into at least two separate portions.

3. The improved shippable speaker box of claim 1, combined in a kit comprising:
a) said five panels, folded into said configuration wherein four panels of said five panels are parallel and said four flexible couplings remain coupled; and
b) said sixth and said seventh panels are stacked parallel to said four parallel panels to form a stack.

4. The improved shippable speaker box of claim 3, wherein said kit further comprises:
a) at least one securer; and
b) at least one construction element.

5. The improved shippable speaker box of claim 4, wherein said securer comprises a bundle tie lock further comprising a reinforced shoulder, said shoulder operable to be used as a fulcrum for an adjustable pliers to tighten said bundle tie circumferentially around said speaker box during assembly.

6. The improved shippable speaker box of claim 4, wherein said securer comprises an alignment frame.

7. The improved shippable speaker box of claim 3, wherein:
a) each of said five panels have a thickness;
b) wherein said middle panel comprises:
i. an external length at least equal to combined said thicknesses of said first and second outermost panels; and
ii. an external length less than external lengths of each of said first and second intermediate panels and each of said first and second outermost panels.

8. The improved shippable speaker box of claim 7, wherein said first and second outermost panels have smaller external lengths than respective said first and second intermediate panels to which said first and second outermost panels are respectively flexibly coupled.

9. The improved shippable speaker box of claim 3, wherein:
a) at least one of said sixth panel and said seventh panel comprises a connector cup opening;
b) said kit further comprises said connector cup; and
c) at least one panel of said four panels comprises at least one speaker opening.

10. The improved shippable speaker box of claim 9, wherein:
a) said panel comprising said connector cup opening and said panel comprising said speaker opening are adjacent in said stack;
b) said connector cup opening and said speaker opening at least partially align to form a stack void within said stack; and
c) at least one construction element of said kit is packaged to be shipped within said stack void.

11. The improved shippable speaker box of claim 9, wherein said kit further comprises a retail package:
a) operable to contain:
i. said stack;
ii. said at least one construction element;
iii. said connector cup; and
iv. said at least one securer; and
b) bearing, on at least one surface of said retail package, at least one of:
i. text relating to said speaker box; and
ii. graphics relating to said speaker box.

12. The improved shippable speaker box of claim 3, wherein said at least one construction element of said kit comprises at least one of:
a) at least one adhesive;
b) assembly hardware; and
c) at least one set of instructions.

13. The improved shippable speaker box of claim 1, further comprising first and second aligned grooves in each panel of said five panels, wherein said first and second grooves are configured to receive at least a portion of said first and said second side panels, respectively.

14. The improved shippable speaker box of claim 13, further comprising at least one third groove across at least one four panels of said seven panels, said at least one third groove operable to receive at least one eighth panel, wherein said at least one eighth panel is operable, when said speaker box is assembled, as a partition interior to said speaker box.

15. The improved shippable speaker box of claim 1, wherein said four flexible couplings comprise one piece of flexible fabric coupled to said five panels.

16. An improved shippable speaker box, comprising:
a) five panels flexibly coupled in a linearly aligned sequence with four flexible couplings;
b) wherein said five panels are operable to be folded together into a stacked configuration wherein four panels of said five panels are stacked generally parallel to each other without uncoupling said four flexible couplings;
c) wherein each of said five panels have a thickness;
d) wherein said five panels comprise:
i. one middle panel having first and second sides;
ii. first and second intermediate panels flexibly coupled to said middle panel on respective first and second sides of said middle panel;
iii. first and second outermost panels flexibly coupled to respective first and second said intermediate panels to form said linearly aligned sequence; and
e) wherein said middle panel comprises:
i. an external length at least as great as combined said thicknesses of said first and second outermost panels;
ii. an external length less than external lengths of each of said first and second intermediate panels and each of said first and second outermost panels;
iii. said first and second outermost panels have smaller external lengths than said respective first and second intermediate panels to which said first and second outermost panels are respectively flexibly coupled;
f) a sixth panel, comprising a first side panel sized and shaped to be circumferentially engaged by said five panels;
g) a seventh panel, comprising a second side panel sized and shaped to be circumferentially engaged by said five panels, wherein said five panels, said sixth panel, and said seventh panel comprise seven panels operable to be assembled into said improved shippable speaker box;
h) first and second aligned grooves in each panel of said five panels, wherein said first and second grooves are configured to receive at least a portion of said first and said second side panels, respectively
i) wherein one of said sixth panel and said seventh panel comprises a connector cup opening;
j) wherein at least one of said first and second intermediate panels and said first and second outermost panels comprises at least one speaker opening;
k) wherein said five panels are operable to be folded to form said speaker box by:
i. circumferentially engaging edges of said sixth and said seventh panels; and
ii. being secured thereto with at least one of:
1. adhesive, operable to adhere said sixth and seventh side panels to said five panels; and
2. at least one securer;
l) wherein said five panels are operable to be folded into said stacked configuration and said sixth panel and said seventh panel are operable to be stacked parallel and adjacent to said five folded panels to form a stack.

17. The improved shippable speaker box of claim 16, further comprising at least one third groove across at least four panels of said seven panels, said at least one third groove operable to receive at least one eighth panel, wherein said at least one eighth panel is operable, when said speaker box is assembled, as a partition interior to said speaker box.

18. The improved shippable speaker box of claim 16, combined in a kit comprising:
a) said stack; and
b) a retail package containing said stack.

19. The improved shippable speaker box of claim 18, wherein said kit further comprises:
a) at least one construction element comprising at least one of:
i. said adhesive;
ii. hardware; and
iii. at least one set of instructions; and
b) said at least one securer.

20. The improved shippable speaker box of claim 19, wherein said at least one securer is at least one of:
a) at least one bundle tie; and
b) at least one attachable alignment frame.

21. The improved shippable speaker box of claim 20, wherein said bundle tie comprises a bundle tie lock further comprising a reinforced shoulder, said shoulder operable to be used as a fulcrum for adjustable pliers to tighten said bundle tie circumferentially around said speaker box.

22. The improved shippable speaker box of claim 19, wherein:
a) said retail package has at least one package void; and
b) said at least one construction element is shippable in said at least one package void.

23. The improved shippable speaker box of claim 16, wherein said four flexible couplings comprise one piece of flexible fabric coupled to said five panels.

24. An improved shippable speaker box, comprising:
a) five panels flexibly coupled in a linearly aligned sequence with four flexible couplings, wherein said four flexible couplings comprise one piece of flexible fabric coupled to said five panels;
b) wherein said five panels are operable to be folded together into a folded configuration wherein four panels of said five panels are stacked generally parallel to each other without uncoupling said four flexible couplings;
c) said five linearly arranged panels comprise:
i. one middle panel comprising first and second opposing sides;
ii. first and second intermediate panels flexibly coupled to said middle panel on said respective first and second opposing sides of said middle panel;
iii. first and second outermost panels flexibly coupled to respective said first and second intermediate panels to form said linearly aligned sequence; and
d) wherein said middle panel comprises:
i. an external length at least as great as said thicknesses of each of said first and second outermost panels combined;
ii. an external length less than external lengths of each of said first and second intermediate panels and each of said first and second outermost panels;
iii. each said first and second outermost panel further comprising a smaller external length than said respective first and second intermediate panel to which each said first and second outermost panel is coupled;
e) a sixth panel, comprising a first side panel sized and shaped to be circumferentially engaged by said five panels;
f) a seventh panel, comprising a second side panel sized and shaped to be circumferentially engaged by said five panels, wherein said five panels, said sixth panel, and said seventh panel comprise seven panels operable to be assembled into said improved shippable speaker box;
g) wherein said five panels comprise first and second aligned grooves in each panel of said five panels, wherein said first and second aligned grooves are configured to receive a portion of said first and said second side panels, respectively,
h) wherein one of said sixth panel and said seventh panel comprises a connector cup opening;
i) wherein at least one of said four panels comprises a speaker opening sized, shaped, and located to receive a speaker;
j) wherein said five panels are operable to be folded about said flexible couplings to form said speaker box by:
i. circumferentially engaging said sixth and said seventh panels; and
ii. being secured thereto by a securer comprising at least one of:
1. at least one bundle tie with a bundle tie lock; and
2. at least one attachable alignment frame;
k) wherein said five panels are operable to be folded about said flexible couplings into said folded configuration and said sixth panel and said seventh panel are operable to be stacked parallel and adjacent to said five folded panels to form a stack;
l) said stack combined in a kit further comprising:
i. said at least one securer;
ii. said connector cup; and
iii. at least one of:
1. said adhesive, operable to adhere said sixth and seventh side panels to said five panels;
2. hardware;
3. at least one set of instructions; and
4. a retail package.

25. The improved shippable speaker box of claim 24, further comprising:
a) at least one eighth panel operable, when said speaker box is assembled, to partition space within said assembled speaker box; and
b) at least one third aligned grove across at least one four panels of said seven panels, operable to receive at least a portion of said at least one eighth panel.
